(19) United States
(12) Patent Application Publication
(10) Pub. No.: US 2006/0220426 A1
(43) Pub. Date: Oct. 5, 2006

(54) Rollover deployed reclining seatback

(76) Inventors: Edward Moffatt, Orinda, CA (US); Eddie Cooper, Scottsdale, AZ (US)

Correspondence Address: DONALD J LENKSZUS, PO BOX 3064, CAREFREE, AZ, 85377-3064, US

(21) Appl. No.: 11/099,425

(22) Filed: Apr. 5, 2005

(51) Int. Cl. B60N 2/42; B60N 2/427; B60R 21/13; B60R 21/013

(52) U.S. Cl. 297/216.19; 297/216.1; 297/216.15; 297/216.13; 297/216.14; 297/216.16

(57) ABSTRACT

A vehicle seat system utilizes a rollover sensor coupled to an actuator that is actuated under rollover conditions to rotate either the seatback or the seatback and seat cushion to a protective position such that the head of a seated occupant is brought closer to the vehicle floor when the vehicle undergoes a rollover condition.

### FIELD OF THE INVENTION

The present invention pertains to vehicle safety arrangements and methods, in general, and to a safety arrangement and method for reducing injuries resulting from vehicular rollovers, in particular.

### BACKGROUND OF THE INVENTION

In the United States, there are approximately 250,000 rollover crashes of light vehicles per year. These rollovers typically cause about 10,000 fatalities and 16,000 serious injuries. Approximately 20% of fatalities are to occupants who were wearing seatbelts. For seat belted occupants, head and neck injuries are leading sources of HARM (a measure of the societal cost of injuries).

During rollover collisions, seat belted occupants typically move upward and outward relative to the vehicle interior, placing their heads near the top of the window or side of the roof. Significant impacts of the vehicle roof into the ground are likely to occur directly proximal to this head position. Severe head and neck impacts are most likely to result from head impact with the interior of the vehicle roof or the ground when the side of the roof strikes the ground.

It is highly desirable to provide an arrangement and method that will significantly reduce the head and neck injuries that may result from rollover crashes.

### SUMMARY OF THE INVENTION

In accordance with the principles of the invention, a vehicle seat system for a vehicle seat mounted on a floor of a vehicle is provided. The system comprises a seat cushion for normally supporting a seated occupant at a given position relative to the vehicle floor and a seat back for normally supporting the back of the seated occupant at a given position relative to the seat cushion. A rollover sensor is coupled to an actuator that is actuated to rotate the seat back to a protective position such that the head of a seated occupant is brought closer to the vehicle floor when the vehicle undergoes a rollover condition.

In one embodiment of the invention, a latch is coupled to the seat back to retain the seat back in the protective position.

In a first embodiment of the invention, the seat back is rotatable to the protective position independent of the seat cushion.

In accordance with another aspect of the invention, the seat comprises a seatbelt torso restraint carried by said seat back.

In accordance with yet another aspect of the invention, the seatbelt torso restraint associated with said seat is movable from a first position to a second position coincident with the seat back being moved to the protective position

In a second embodiment of the invention, the said seat cushion is rotated to a protective position along with the seat back. The seat cushion protective position is one in which the front of the seat cushion is raised relative to the rear of the seat cushion.

In an embodiment of the invention, a latch is coupled to the seat back to retain the seat in the protective position.

In accordance with the principles of the invention a method of utilizing a vehicle seat assembly comprising a seat cushion and a seat back to attempt to minimize injuries to an occupant seated on said seat assembly in a rollover condition, includes normally supporting the occupant on the vehicle seat with the seat back in a given vertical position; sensing a vehicle rollover condition; and rotating the vehicle seat back to a protective position in response to sensing the vehicle rollover condition.

In accordance with an aspect of the invention, the method includes normally supporting the occupant on the vehicle seat with the seat cushion in a given horizontal position; and rotating the seat cushion with the seat back in response to sensing the vehicle rollover condition, such that the front of the seat cushion is raised relative to the rear of the seat cushion.

In accordance with an aspect of the invention, the method includes retaining the seat cushion and the seat back in the protective position.

Still further in accordance with the principles of the invention, the method comprises providing rollover sensing apparatus; providing a controller responsive to the rollover sensing apparatus; and providing a drive apparatus coupled to said seat and responsive to said controller to move said seatback to said protected position.

### BRIEF DESCRIPTION OF THE DRAWING

The invention will be better understood from a reading of the following detailed description of illustrative embodiments of the invention in which like elements are identified with like designators, and in which:

FIG. 1 illustrates a vehicle portion with a person in the front seat;

FIG. 2 illustrates the vehicle portion of FIG. 1 with the seatback in a protective position;

FIG. 3. illustrates the vehicle portion of FIG. 1 with the seat cushion and seatback in a protective position;

FIG. 4 illustrates a first seat in accordance with the principles of the invention;

FIG. 5 illustrates the seat of FIG. 4 in a protective position;

FIG. 6 illustrates a second seat in accordance with the principles of the invention; and

FIG. 7 illustrates the seat of FIG. 6 in a protective position.

### DETAILED DESCRIPTION

In accordance with the principles of the invention a new vehicle seat/seatbelt arrangement is provided that reduces the likelihood of serious injury or death to a seatbelted occupant in a vehicle rollover. In accordance with the principles of the invention this reduction in injury potential is obtained by moving and restraining the occupant away from the roof/ground where significant head, neck and upper torso injuries are likely to occur during rollover. Still further in accordance with the invention, a vehicle seat design incorporates a reclining seatback and seatbelt shoulder anchor which is powered into a reclined position in the event that a rollover crash is sensed by an existing onboard rollover sensor.

In the automotive industry, seats are described as having a “cushion” which the buttocks sit on, and a “seatback” which supports the torso. As used in herein, the terms “cushion” and “seatback” shall be understood to have the automotive industry meanings ascribed thereto.

For the comfort of occupants, reclining seatbacks have long existed in vehicles. Operated either mechanically or electrically, they allow the person to lay the seatback rearward. Many have enough rearward travel to allow sleeping in a semi- reclined position.

We have determined that if an occupant could be seatbelted into this reclined position during a rollover it would greatly reduce the occupant's chance of partial ejection out the side window or the occupant's contact with the roof, and it would keep the occupant's head away from the areas of the vehicle which are most likely to experience the most hazardous impacts.

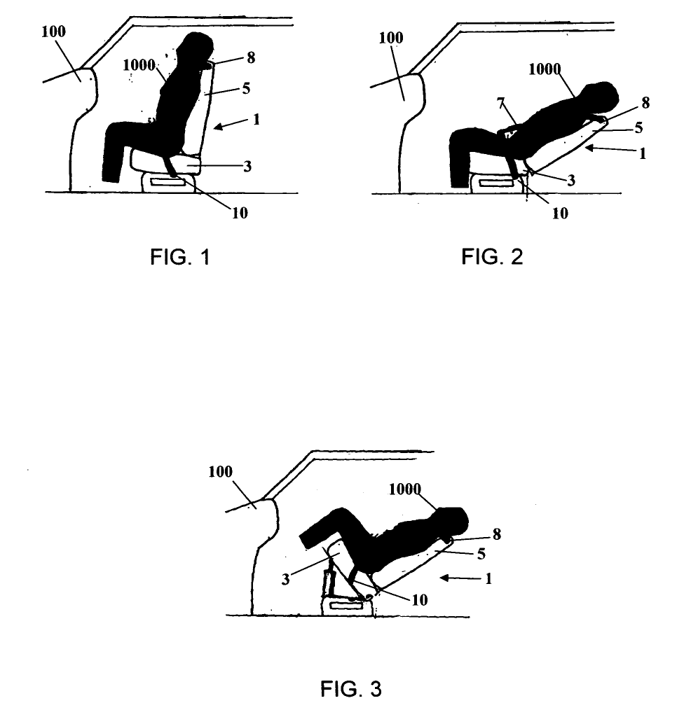

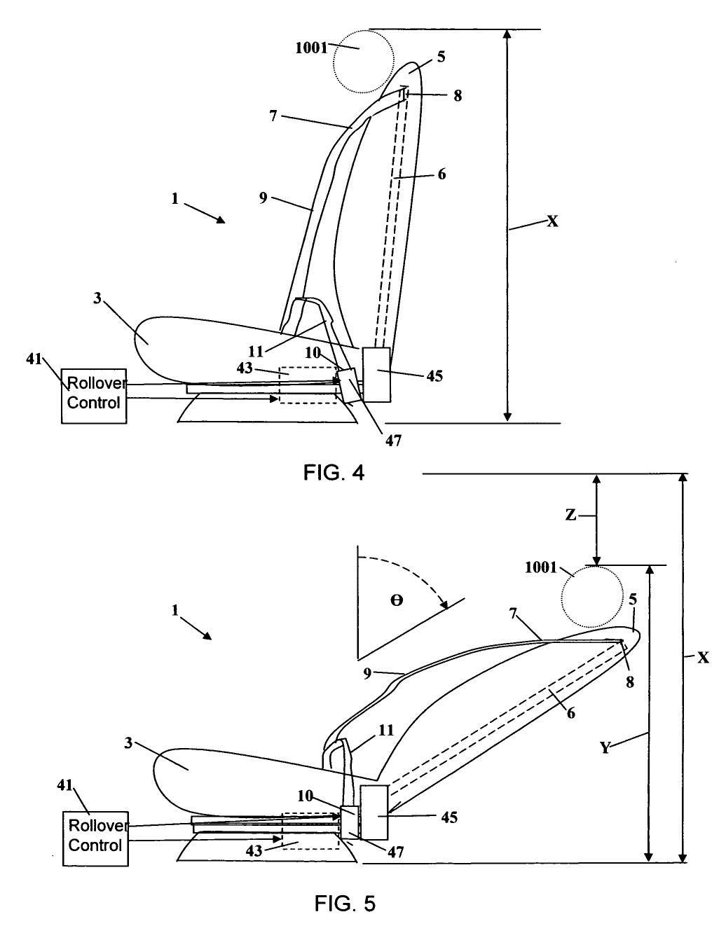

A vehicular seat assembly of the present invention shown in FIG. 1 is designated generally at 1. A vehicle occupant 1000 is shown seated in seat assembly 1. Seat assembly 1 is disposed within a vehicle 100. Seat assembly 1, includes a seat cushion 3 and a seat back 5 extending generally upwardly at the rear of seat cushion 3. A seat belt webbing 7 extends outwardly from the top front 8 of seat back 5 along the outboard side of seat assembly 1. Webbing 7 extends downwardly along outboard side of seat assembly 1 where one end 10 of webbing 7 is attached to seat assembly 1. A latchplate, which is not shown, is attached to seat belt webbing 7 the seatback upper end and end 8. A buckle mechanism, which is not shown, is attached to the inboard side of seat assembly 1 for reception of the clasp therein. When the latchplate is inserted into the buckle mechanism, the webbing 7 forms a shoulder belt or torso restraint 9 and a lap belt 11 which are more clearly seen in FIGS. 4-7.

The terms “inboard” and “outboard” are used merely as a convenience to designate the sides of the seat assembly 1. As is the typical case, the shoulder belt 9 extends from the upper outboard side of the seat assembly 1 to the lower inboard side of the seat assembly 1. The seat assembly of the present invention has been shown and described in this manner. However, nothing herein should be construed so as to limit the seat assembly of the present invention to such a belt configuration. In other configurations, the upper end of the webbing may be attached to other vehicle portions such as the vehicle “B” column.

The operation of our new seat design is facilitated by the recent development and availability of rollover sensors which are currently being installed in some production vehicles. One type of rollover sensors that are commercially available continuously measure the roll angle and roll velocity of a vehicle. If the sensor measures that the vehicle is definitely going to roll over, it sends an electrical signal which deploys various protection devices, such as side window airbags.

In accordance with the principles of the invention, rollover sensing apparatus and deployment technology 41 shown in block forming FIGS. 4-7 is utilized to send a signal that reclines the seatback and moves the seatbelt during a rollover. The seatback and occupant are forced into a reclined protective position as shown in FIGS. 5 and 7 when the rollover sensing apparatus 41 provides a rollover indication signal. Seat assembly 1 includes apparatus that moves the seat to the protective position when the rollover sensing apparatus generates a positive firing signal. In the illustrative embodiment of the invention, the approximate time for movement of the seat to the protective position is less than one second.

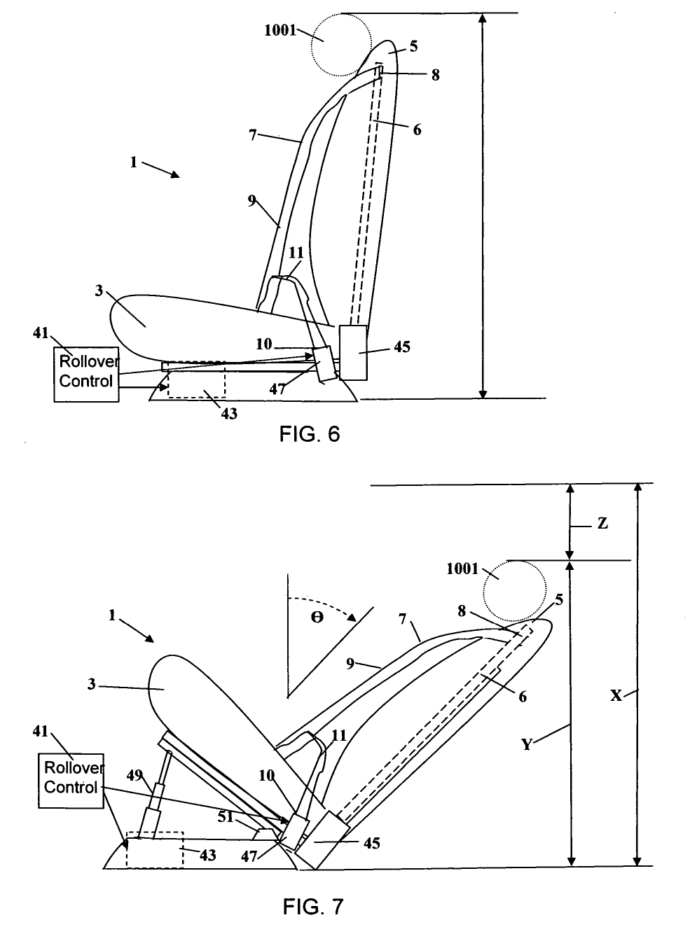

The two illustrative embodiments of FIGS. 2 and 3 are shown in greater detail in FIGS. 4, 5 and FIGS. 6, 7, respectively. In the first illustrative embodiment shown in FIGS. 4, 5 the seatback is forced into the reclined or protective position by rotating it rearward relative to the seat cushion. In the second illustrative embodiment shown in FIGS. 6, 7 the reclined position is obtained by rotating both the seat cushion and seatback rearward.

Turning now to FIGS. 4, 5 seat assembly 1 includes a cushion 3 and a seat back 5.

Seat assembly 1 includes a pair of fore and aft extending rails disposed along the inboard and outboard sides of seat assembly 1. Each rail has a corresponding track portion adapted to engage a pair of slide rails mounted on each fixed rail. The slide rails include the track portion as well as a riser portion extending upward from the track portion.

Seat assembly 1 also includes a seat back frame 6 that is pivotally mounted to the seat cushion and extends upward from the rear of seat cushion 3 in a conventional manner. Seat back frame 6 may include a portion to which seat belt webbing 7 attaches.

Seat assembly 1 includes a seat recliner mechanism 45 that is coupled to seat back frame 6. Seat recliner mechanism 45 permits the occupant to rotate the seat back about a pivot.

The vehicle in which seat 1 is carried includes rollover sensing apparatus 41. In the event that a rollover condition is detected by rollover sensing apparatus 41, rollover sensing apparatus 41 causes an actuator 43 to operate. Operation of actuator 43 causes seatback 5 to be rotated from its first or normal position to a second reclined or protected position as shown in FIG. 5. In FIG. 5, the amount of rotation of seatback 5 is shown as θ. By rotating seatback 5, in this manner, the top of head 1001 of an occupant 1000 is moved from a position of a first height X above the vehicle floor to a position where the top of the head 1001 is at a second height Y above the vehicle floor. The difference Z between the two heights is the additional amount of protective distance between the top of head 1001 and the roof of the vehicle 100. In this protected position, the distance between the head 1001 and the roof of the vehicle 100 is increased by several inches, thereby reducing the likelihood that a traumatic head or spinal injury will result from a rollover.

In the embodiment of FIGS. 4, 5 actuator 43 is an expanding-gas force-generating device (known as a “pyrotechnic device”) of a type that is known. Actuator 43 in other embodiments may be an electric motor, or a stored energy device such as a spring. This force generating device may be a rotary or linear device. Actuator 43 operates on a seat back mechanism shown in block form at 45. Seat back mechanism may be the reclining mechanism found in many vehicles for moving the seat back 5 to a reclined position, or it may be an additional mechanism. In addition to reclining seat back 5 to a reclined position as shown in FIG. 5, mechanism 45 latches seat back 5 in place when it is disposed to the protective position.

Actuator 43 is also utilized to activate seat belt tightening mechanism 47. The seat belt tightening mechanism may be of a type known in the automotive arts.

FIGS. 5 and 6 illustrate the second embodiment of the invention, in which seatback 5 and seat cushion 3 are both rotated rearward. In the embodiment shown, seatback 5 and seat cushion 3 are both rotated together as a unit. However, it will also be understood by those skilled in the art that seatback 5 and seat cushion 3 may be separately rotated.

Seat assembly 1 includes a pair of fore and aft extending rails disposed along the inboard and outboard sides of seat assembly 1. Each rail has a corresponding track portion adapted to engage a pair of slide rails mounted on each fixed rail. The slide rails include the track portion as well as a riser portion extending upward from the track portion.

Seat assembly 1 also includes a seat back frame 6 that is pivotally mounted to the slide rails and extends upward from the rear of seat cushion 3 in a conventional manner.

Seat assembly 1 includes a seat recliner mechanism 45 that is coupled to seat back frame 6. Seat recliner mechanism permits the occupant to rotate the seat back about pivot 51.

In this embodiment, actuator 43 includes a lift mechanism 49 that elevates the front of seat cushion 3 when signaled by rollover sensing apparatus 41. Lift mechanism 49 lifts the front of the seat cushion relative to the vehicle floor, while pivoting it around a pivot axle 51 at the rear of seat cushion 3. Depending upon the specific application, lift mechanism may be utilized to elevate the seat adjustment track along with seat cushion 3.

Operation of actuator 43 causes seat cushion 3 and seatback 5 to be rotated from its first or normal position to a second reclined or protected position as shown in FIG. 7. In FIG. 7, the amount of rotation of seatback 5 is shown as θ. By rotating seat cushion 3 and seatback 5 as a unit, in this manner, the top of head 1001 of an occupant 1000 is moved from a position of a first height X above the vehicle floor to a position where the top of the head 1001 is at a second height Y above the vehicle floor. The difference Z between the two heights is the additional amount of protective distance between the top of head 1001 and the roof of the vehicle 100. In this protected position, the distance between the head 1001 and the roof of the vehicle 100 is increased by several inches, thereby reducing the likelihood that a traumatic head or spinal injury will result from a rollover.

As with the embodiment of FIGS. 4, 5, the actuator may be any one of a number of known fast acting apparatus including, but not limited to, an electric motor, or pyrotechnic device, or stored mechanical energy device such as a spring.

As with the embodiment of FIGS. 4, 5, a ratchet or latch device is used to hold seat assembly 1 in the it in the protective position and insure that it does not return to its upright position during the crash. The ratchet or latch may be incorporated into lift mechanism 49.

Actuator 43 is also utilized to activate seat belt tightening mechanism 47. The seat belt tightening mechanism may be of a type known in the automotive arts.

Moving the seatbelt with the occupant can be accomplished for different seatbelt designs. Some current production vehicles provide seatbelts which have the lapbelt anchored to the seat cushion and the upper torso belt anchored to the seatback as shown in the drawings. This design is known generically as a “seat integrated seatbelt”.

In the illustrative embodiments of the invention shown and described, the upper torso belt anchor is moved rearward along with the top of the seatback. The exact positioning of the anchors will be designed to provide tightening of the seatbelt during the crash (“pretensioning”) as the seatback/seatbelt is forced into recline.

In other embodiments of the invention in vehicles in which the upper torso seatbelt anchor is not integrated with the seatback, but is installed in a fixed position to the body of the vehicle, the rollover sensing apparatus may be utilized to trigger a pretensioned device which will move the anchor downward along with the seatback. This may be accomplished by disposing the upper anchor and retractor on a pivoting arm or on a track.

The invention has been described in terms of several embodiments. It will be appreciated by those skilled in the art that various changes and modifications may be made to the embodiments shown without departing from the spirit or scope of the invention. It is intended that such changes and modifications be included within the scope of the invention. In addition, it is intended that the invention not be limited by the illustrative embodiments shown and described but that the invention be accorded the broadest scope allowed under the law and that the invention is defined and limited by the claims appended hereto.

What is claimed is:

1. A vehicle seat system for a vehicle seat mounted on a floor of a vehicle, comprising:
a seat cushion for normally supporting the legs and buttocks of a seated occupant at a given position relative to the vehicle floor;
a seat back for normally supporting the torso of said seated occupant at a given position relative to said seat cushion;
a sensor for providing an activation signal when the vehicle undergoes a condition indicative of a rollover condition;
an actuator coupled to said sensor and actuatable to rotate said seat back to a protective position such that the head of a seated occupant is brought closer to said vehicle floor when said vehicle undergoes said condition.

2. A vehicle seat system in accordance with claim 1, comprising:
a latch coupled to said seat back to retain said seat in said protective position.

3. A vehicle seat system in accordance with claim 1, wherein:
said seat back is rotatable to said protective position independent of said seat cushion.

4. A vehicle seat system in accordance with claim 3, comprising:
a seatbelt torso restraint carried by said seat back to retain said torso.

5. A vehicle seat system in accordance with claim 4, comprising:
an attachment affixing said seatbelt torso restraint to said seat back.

6. A vehicle seat system in accordance with claim 3, comprising:
a seatbelt torso restraint not carried by said seat back, said seatbelt torso restraint being affixed to a member movable from a first position to a second position coincident with said seat back being moved to said protective position

7. A vehicle seat system in accordance with claim 1, wherein;
said seat cushion is rotated to a protective position along with said seat back.

8. A vehicle seat system in accordance with claim 7, wherein:
said seat cushion protective position is one in which the front of said seat cushion is raised relative to the rear of said seat cushion.

9. A vehicle seat system in accordance with claim 7, comprising:
a latch coupled to said seat back to retain said seat in said protective position.

10. A vehicle seat system in accordance with claim 7, comprising:
a seatbelt torso restraint carried by said seat back.

11. A vehicle seat system in accordance with claim 10 comprising:
an attachment affixing said seatbelt torso to said seat back.

12. A vehicle seat system in accordance with claim 7, comprising:
a seatbelt torso restraint not carried by said seat back, said seatbelt torso restraint being affixed to a member movable from a first position to a second position coincident with said seat back being moved to said protective position.

13. A method of utilizing a vehicle seat assembly comprising a seat cushion and a seat back to attempt to minimize injuries to an occupant seated on said seat assembly in a rollover condition, comprising:
normally supporting the occupant on the vehicle seat with the seat back in a given vertical position;
sensing a vehicle rollover condition; and
rotating said vehicle seat back to a protective position in response to sensing said vehicle rollover condition.

14. A method in accordance with claim 13, comprising:
latching said vehicle seat back is said protective position.

15. A method in accordance with claim 13, comprising:
normally supporting the occupant on the vehicle seat with the seat cushion in a given horizontal position;
rotating said seat cushion with said seat back in response to sensing said vehicle rollover condition, such that the front of said seat cushion is raised relative to the rear of said seat cushion.

16. A method in accordance with claim 15, comprising:
retaining said seat cushion and said seat back in said protective position.

17. A method in accordance with claim 13, comprising:
normally supporting the occupant on the vehicle seat with the seat cushion in a given horizontal position;
rotating said seat cushion with said seat back to a protective position in response to sensing said vehicle rollover condition, such that the front of said seat cushion is raised relative to the rear of said seat cushion in said given horizontal position.

18. A method in accordance with claim 17, comprising:
retaining said seatback and said seat cushion in said protective position.

19. A method in accordance with claim 18, comprising:
providing one or more latches to retain said seatback in said protective position.

20. A method in accordance with claim 13, comprising:
providing rollover sensing apparatus:
providing a controller responsive to said rollover sensing apparatus;
providing a drive apparatus coupled to said seat and responsive to said controller to move said seatback to said protected position.

21. A method in accordance with claim 20, comprising;
selecting said drive apparatus to be one of a pyrotechnic device, an electrically actuated device; an energy storage mechanical device; or a spring.
